(19) United States
(12) Patent Application Publication
(10) Pub. No.: US 2016/0334650 A1
(43) Pub. Date: Nov. 17, 2016

(54) Tunable Wavelength-Flattening Element For Switch Carrying Multiple Wavelengths Per Lightpath

(71) Applicant: Huawei Technologies Co., Ltd., Shenzhen (CN)

(72) Inventors: Patrick Dumais, Ottawa (CA); Dominic John Goodwill, Ottawa (CA)

(21) Appl. No.: 14/708,535

(22) Filed: May 11, 2015

(51) Int. Cl. G02F 1/025; G02F 1/225; G02F 1/01

(52) U.S. Cl. CPC G02F 1/025; G02F 1/0147; G02F 1/225; G02F 2001/0152

(57) ABSTRACT

A tunable optical filter including a first coupler configured divide an optical signal into a first portion and a second portion, a first waveguide configured to receive the first portion of the optical signal, a second waveguide configured to receive the second portion of the optical signal, an adjustable phase element operatively coupled to the first waveguide for adjusting an optical path length of the first waveguide, a P-I-N junction operatively coupled to one of the first waveguide and the second waveguide for introducing a loss into one of the first portion of the optical signal and the second portion of the optical signal, and a second coupler operatively coupled to the first waveguide and the second waveguide, wherein the second coupler is configured to recombine the first portion of the optical signal with the second portion of the optical signal to generate a spectrally modulated optical signal.

### BACKGROUND

Silicon optical waveguides have great potential as a platform for ultra-small photonic integrated circuits (PICs). In a typical PIC structure, a silicon (Si) core with high refractive index is surrounded by a low refractive index material, typically silicon dioxide (SiO₂). This structure forms an optical waveguide, typically used at communications wavelengths such as the 1310 nanometer (nm) or 1550 nm bands, wavelengths for which the silicon and silicon dioxide are transparent.

The silicon PIC structure may be formed using a lithographically-defined layout of single mode and multimode waveguide elements, the whole forming the photonic circuit. Alternate materials for the PIC structure include gallium arsenide (GaAs), indium phosphide (InP), lithium niobate (LiNbO₃), lanthanum-doped lead zirconium titanate (PLZT), silicon nitride (SiN), and silicon oxynitride (SiON).

The waveguide elements may be advantageously utilized in wavelength division multiplexing (WDM) networks. In such networks, the waveguide elements may receive optical signals including several channels from a switch matrix. Unfortunately, each of the channels may have a different transmission power due to the individual optical components within the switch matrix. If the power of each channel is not equalized, an undesirable channel dependent optical signal-to-noise ratio (OSNR) may occur.

### SUMMARY

In one embodiment, the disclosure includes a tunable optical filter including a first coupler configured to receive an optical signal and divide the optical signal into a first portion and a second portion, a first waveguide operatively coupled to the first coupler, wherein the first waveguide is configured to receive the first portion of the optical signal, a second waveguide operatively coupled to the first coupler, wherein the second waveguide is configured to receive the second portion of the optical signal, an adjustable phase element operatively coupled to the first waveguide for adjusting an optical path length of the first waveguide, a P-I-N junction operatively coupled to one of the first waveguide and the second waveguide for introducing a loss into one of the first portion of the optical signal and the second portion of the optical signal, and a second coupler operatively coupled to the first waveguide and the second waveguide, wherein the second coupler is configured to recombine the first portion of the optical signal with the second portion of the optical signal to generate a spectrally modulated optical signal.

In another embodiment, the disclosure includes a tunable optical filter including a first coupler configured to receive an optical signal and divide the optical signal into a first portion and a second portion, a first waveguide operatively coupled to the first coupler, the first waveguide configured to receive the first portion of the optical signal and including a heater, wherein the heater is configured to provide a phase shift, a second waveguide operatively coupled to the first coupler, the second waveguide configured to receive the second portion of the optical signal, a P-I-N junction in the first waveguide, wherein the P-I-N junction is configured to introduce an adjustable optical power loss into the first portion of the optical signal, and a second coupler operatively coupled to the first waveguide and the second waveguide, wherein the second coupler is configured to recombine the first portion of the optical signal with the second portion of the optical signal to generate a spectrally modulated optical signal.

In yet another embodiment, the disclosure includes a method of tuning an optical signal including routing a first portion of the optical signal to a first waveguide and a second portion of the optical signal to a second waveguide, generating an adjustable phase shift in the first portion of the optical signal, introducing an optical loss in one of the first portion of the optical signal and the second portion of the optical signal, and recombining the first portion of the optical signal with the second portion of the optical signal to produce a spectrally modulated optical signal.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a tunable optical filter.

FIG. 2 is a graph of a transmission power of an optical signal input into the tunable optical filter.

FIG. 3 is a graph of a transmission power profile within a power spectrum band.

FIG. 4 is a graph of a bell-shaped transmission power profile within a power spectrum band.

FIG. 5 is a graph of an inverted bell-shaped transmission power profile within a power spectrum band.

FIG. 6 is a graph of a transmission power profile within a power spectrum band.

FIG. 7 is a graph of a transmission power of the optical signal output from the tunable optical filter.

FIG. 8 is a flowchart of an embodiment of a method of tuning an optical signal.

### DETAILED DESCRIPTION

It should be understood at the outset that although an illustrative implementation of one or more embodiments are provided below, the disclosed systems and/or methods may be implemented using any number of techniques, whether currently known or later developed. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein is a tunable wavelength-flattening element for an optical switch carrying multiple wavelengths per lightpath. As will be more fully explained below, the tunable wavelength-flattening element mitigates a channel dependency of an optical signal-to-noise ratio (OSNR) and maintains a certain flatness of power relative to wavelength. The tunable wavelength-flattening element creates a loss profile to compensate for the wavelength dependence loss of a switch. By adjusting the loss profile, the static, average loss of the switch is compensated. In addition, dynamic changes in loss spectrum may be compensated to the first degree. The tunable wavelength-flattening element also offers slow, but dynamic, compensation.

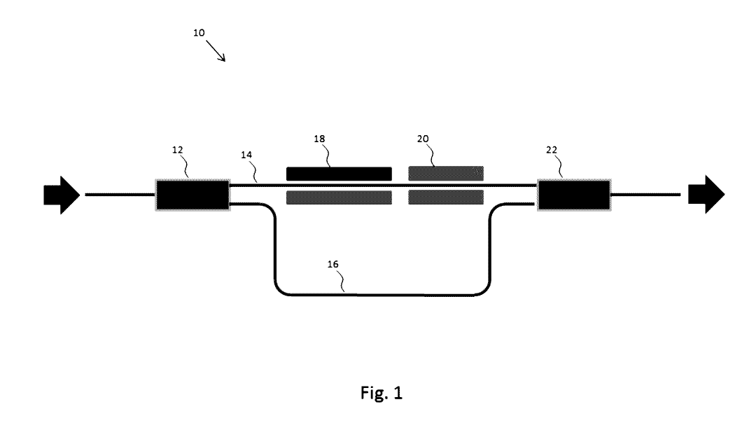

FIG. 1 is a schematic diagram of an embodiment of a tunable optical filter 10. In an embodiment, the optical filter 10 is a modified integrated Mach-Zehnder (MZ) interferometer. As such, the optical filter 10 is suited for optical switching and filtering operations. The optical filter 10 is configured to receive, for example, an optical signal from an optical switch matrix (not shown) upstream of the optical filter 10. As will be more fully explained below, the optical filter 10 is used to flatten the wavelength-dependent loss produced by the optical switch matrix. In other words, the optical filter 10 may be tuned to compensate for static and dynamic variations of loss within an optical switch or a number of other optical components. As shown, the tunable optical filter 10 includes a first optical coupler 12, a first optical waveguide 14, a second optical waveguide 16, a P-I-N junction 18, a phase shift element 20, and a second optical coupler 22.

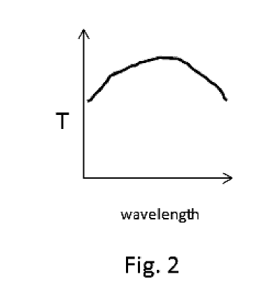

The first optical coupler 12 is configured to receive an optical signal, which is represented by the arrow directed into the optical filter 10 in FIG. 1, from an optical switch matrix or other optical source upstream of the optical filter 10. In an embodiment, the first optical coupler 12 includes a single input and two outputs. However, the first optical coupler 12 may have any number of inputs and any number of outputs in other embodiments. The transmission power of the optical signal that may be received by the first optical coupler is depicted in FIG. 2. As shown, the transmission power (T) of the optical signal received by the first optical coupler 12 varies considerably as a function of wavelength due to loss variations of the upstream optical switch matrix providing the optical signal. For example, the channel at the shortest wavelength may have an optical power of −10 decibels (dBm), the channel corresponding to a middle wavelength may have an optical power of −5 dBm, and the channel at the longest wavelength may have an optical power of −10 dBm. This variable optical loss across the different channels may worsen after each stage in the optical transmission process due to, for example, amplification of the optical signal downstream of the optical filter 10. In addition, the unequal transmission power across the various channels may lead to an undesirable channel-dependent OSNR.

Referring back to FIG. 1, the first optical coupler 12 is configured to split the optical signal into a first portion and a second portion. Therefore, the first optical coupler 12 may be referred to as a beam splitter. In an embodiment, the optical signal may be divided using an even split ratio. In other words, the optical signal is split in a 50/50 ratio such that the first portion of the optical signal carries fifty percent (50%) of the transmission power of the optical signal and the second portion of the optical signal carries the remaining 50% of the transmission power of the optical signal. In an embodiment, the optical signal may be divided using an uneven split ratio to impart a coupler imbalance. For example, the first portion of the optical signal may be 75% while the second portion of the optical signal is the remaining 25%. Those skilled in the art will recognize that other split ratios may be implemented by the first optical coupler 12. The coupler imbalance may be beneficially used to generate a power difference (e.g., power imbalance) within the optical filter 10, as will be more fully explained below.

As shown, the first optical coupler 12 is operatively coupled to the first optical waveguide 14 and the second optical waveguide 16. The first optical waveguide 14 is configured to receive and propagate the first portion of the optical signal through the optical filter 10. Likewise, the second optical waveguide 16 is configured to receive and propagate the second portion of the optical signal through the optical filter 10. In an embodiment, one or both of the first optical waveguide 14 and the second optical waveguide 16 are silicon nanowire waveguides. However, the first optical waveguide 14 and the second optical waveguide 16 may be other types of waveguides in other embodiments.

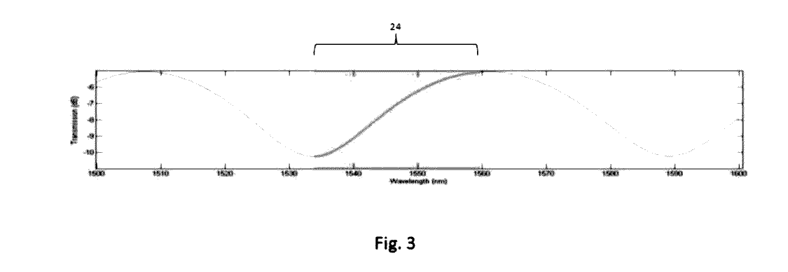

In an embodiment, the first optical waveguide 14 and the second optical waveguide 16 each have a different path length. In other words, the path length of the first optical waveguide 14 and the path length of the second optical waveguide 16 are not the same. In an embodiment, a modulated optical transmission spectrum 24 as shown in FIG. 3 is defined by the power spectrum of the optical signal (e.g., the shaded region in FIG. 3) and generated by the difference in the path length of the first optical waveguide 14 relative to the path length of the second optical waveguide 16. For example, a 10 micron difference in the path lengths of the first optical waveguide 14 and the second optical waveguide 16 is used to generate a modulated optical transmission spectrum 24 of about 30 nanometers (nm). In some embodiments, the difference between the path length of the first optical waveguide 14 and the second optical waveguide 16 is more or less than 10 microns, which correspondingly produces a modulated optical transmission spectrum 24 that is greater or less than 30 nm. In an embodiment, the modulated optical transmission spectrum 24 extends from a wavelength of about 1530 nm to a wavelength of about 1560 nm. However, the modulated optical transmission spectrum 24 may include a different range of wavelengths in other embodiments. In an embodiment, a difference between a path length of the first optical waveguide 14 and a path length of the second optical waveguide 16 is such that a period of spectral modulation is between 40 nm and 80 nm at a reference wavelength of 1550 nm.

Referring back to FIG. 1, the P-I-N junction 18 is operatively coupled to the first optical waveguide 14. In an embodiment, the P-I-N junction 18 is operatively coupled to the second optical waveguide 16. In an embodiment, the P-I-N junction 18 includes an undoped intrinsic semiconductor region (I) between a p-type semiconductor region (P) and an n-type semiconductor region (N). The P-I-N junction 18 is configured to manipulate the first portion of the optical signal propagating through the first optical waveguide 14. In an embodiment, the P-I-N junction 18 manipulates the first portion of the optical signal by introducing free carriers into the first portion of the optical signal. These free carriers generate a transmission power loss (e.g., an optical loss) in the first portion of the optical signal. By way of example, if the first portion of the optical signal entering the P-I-N junction 18 had a transmission power of −5 dBm, the optical loss provided by the P-I-N junction 18 may reduce the transmission power of the optical signal leaving the P-I-N junction 18 to −6 dBm or something less. The optical loss generated in the first portion of the optical signal by the P-I-N junction 18 produces an optical imbalance (e.g., a power imbalance) between the first portion of the optical signal propagating through the first optical waveguide 14 and the second portion of the optical signal propagating through the second optical waveguide 16. By introducing the optical loss, the P-I-N junction 18 is able to dynamically modify the modulation depth of the optical filter 10. The free carriers also change the phase of the first portion of the optical signal. In an embodiment, the heater 20 compensates for this phase change.

In an embodiment, the P-I-N junction 18 is driven or powered by a power source (not shown) that provides a desired level of current to the P-I-N junction 18. The desired level of current may range from, for example, zero milliamps (mA) when the P-I-N junction 18 is off to 5 mA or more when the P-I-N junction 18 is operating to generate the optical loss. The desired level of current needed to drive the P-I-N junction 18 to generate the functionality described herein may be determined experimentally. While a single P-I-N junction 18 is illustrated in FIG. 1, it should be recognized that any number of P-I-N junctions may be operatively coupled to the first optical waveguide 14 in other embodiments. In addition, while a P-I-N junction (e.g., similar to P-I-N junction 18 of FIG. 1) is not operatively coupled to the second optical waveguide 16 in FIG. 1, any number of P-I-N junctions may be operatively coupled to the second optical waveguide 16 in other embodiments.

The phase shift element 20 is shown as a heater operatively coupled to the first optical waveguide 14. In an embodiment, the phase shift element 20 may be operably coupled to the second optical waveguide 16. In an embodiment, the phase shift element 20 and the P-I-N junction 18 may be coupled to different waveguides. The phase shift element 20 is configured to manipulate the first portion of the optical signal propagating through the first optical waveguide 14. In an embodiment, the phase shift element 20 manipulates the first portion of the optical signal by changing the refractive index of the first portion of the optical signal propagating through the first optical waveguide 14, which alters the phase of the first portion of the optical signal. Because the phase of the first portion of the optical signal has been changed, a relative phase difference between the first portion of the optical signal and the second portion of the optical signal is produced. In some embodiments, the phase shift element 20 may be a heater, a thermo-optic heater (e.g., a resistive metal strip or doped silicon resistor), a ring resonator, a P-I-N junction, and a liquid-crystal infiltrated slot waveguide.

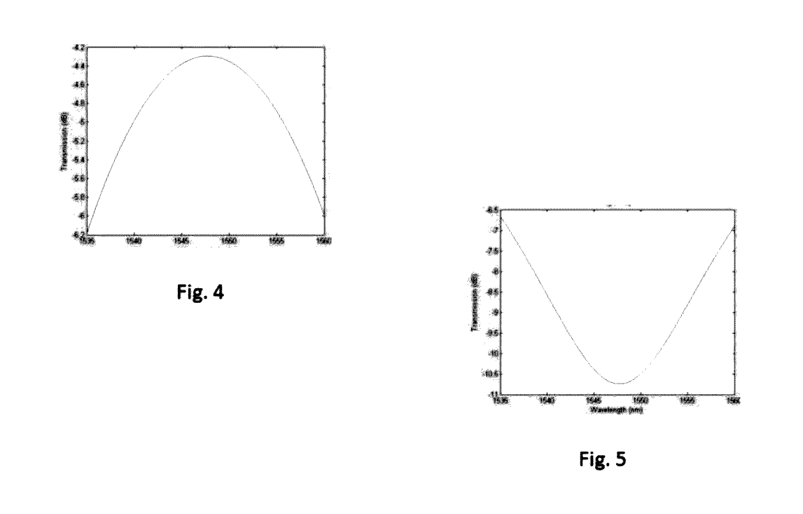

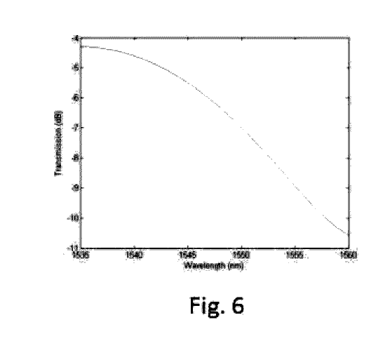

The change in phase of the first portion of the optical signal due to operation of the phase shift element 20 also causes a transmission power profile to shift laterally relative to the modulated optical transmission spectrum 24. By causing the transmission power profile to shift laterally within the modulated optical transmission spectrum 24, a transmission power profile with a particular shape or desired characteristic may be moved into the modulated optical transmission spectrum 24. For example, the transmission power profile within the modulated optical transmission spectrum 24 in FIG. 3 can be shifted left or right until the bell-shaped transmission power profile in FIG. 4 is disposed within the modulated optical transmission spectrum 24. In an embodiment, the transmission power profile within the modulated optical transmission spectrum 24 may have, for example, a shape as shown in FIG. 3, a bell-shape as shown in FIG. 4, an inverted bell-shape as shown in FIG. 5, a shape as shown in FIG. 6, or some combination thereof. The particular shape of the transmission power profile within the modulated optical transmission spectrum 24 may be desired based on, for example, the relative ease of modulation of such shape or for a variety of other reasons.

In an embodiment, the phase shift element 20 is driven or powered by a power source (not shown) that provides a desired level of current to the phase shift element 20. The desired level of current may range from, for example, zero milliamps (mA) when the phase shift element 20 is off to 5 mA or more when the phase shift element 20 is operating to change the phase of the first optical signal propagating through the first optical waveguide 14. The desired level of current needed to drive the phase shift element 20 to generate the functionality described herein may be determined experimentally.

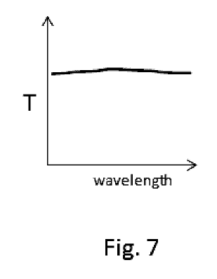

As shown, the second optical coupler 22 is operatively coupled to the first optical waveguide 14 and the second optical waveguide 16. As such, the second optical coupler 22 is configured to receive the first potion of the optical signal propagating through the first optical waveguide 14 and the second portion of the optical signal propagating through the second optical waveguide 16. In an embodiment, the second optical coupler 22 includes two inputs and a single output. However, the second optical coupler 22 may have any number of inputs and any number of outputs in other embodiments. The second optical coupler 22 is configured to recombine the first portion of the optical signal and the second portion of the optical signal into a modulated optical signal, which is represented by the arrow exiting the optical filter 10 in FIG. 1. Because of the power imbalance provided by the P-I-N junction 18 and/or the uneven split ratio of the first optical coupler 12 and the relative phase shift provided by the phase shift element 20, the modulated optical signal has a power loss profile with less power variation over the modulated optical transmission spectrum 24 than the optical signal initially received by the first optical coupler 12. In other words, the transmission power (T) of the modulated optical signal is flatter (see FIG. 7) than the transmission power of the optical signal in FIG. 2. Therefore, variable optical loss across the different channels is not made worse in later stages in the optical transmission process due to, for example, amplification of the optical signal downstream of the optical filter 10.

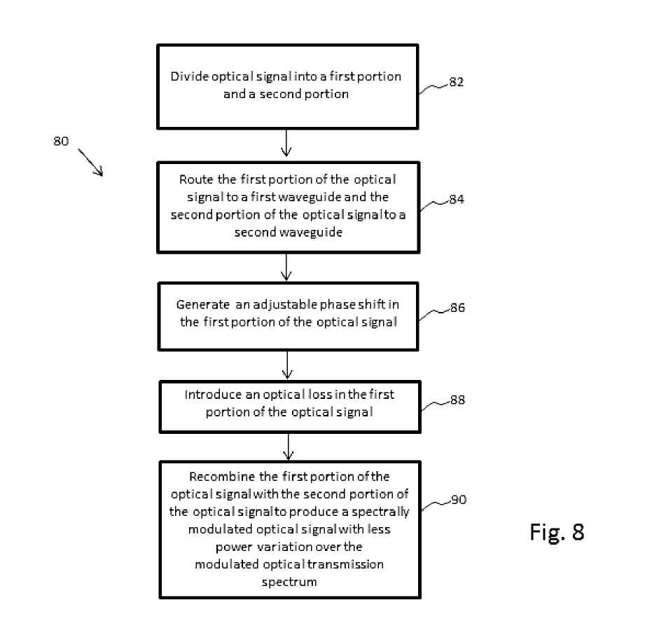

FIG. 8 is a method 80 of optical transmission. The method 80 may be implemented in order to flatten or smooth the transmission power of an optical signal using, for example, the optical filter 10 of FIG. 1. The method 80 may be utilized when the transmission power profile of an input signal has an unacceptable amount of variation over the spectral power range. In block 82, the optical signal is divided into a first portion and a second portion. In an embodiment, the optical signal is divided using the first optical coupler 12 in FIG. 1. In block 84, the first portion of the optical signal is routed to a first optical waveguide 14 and the second portion of the optical signal is routed to a second optical waveguide 16, for example using the first optical coupler 12 in FIG. 1.

In block 86, an adjustable phase shift is generated in the first portion of the optical signal, for example by the phase shift element 20 of FIG. 1. A transmission power profile is shifted laterally within a modulated optical transmission spectrum 24 by generating the relative phase shift in the first portion of the optical signal, for example using the phase shift element 20 of FIG. 1. In block 88, an optical loss is introduced in the first portion of the optical signal by introducing free carriers into the first portion of the optical signal, for example by the P-I-N junction 18 of FIG. 1. In block 90, the first portion of the optical signal is recombined with the second portion of the optical signal to produce a spectrally modulated optical signal. The modulated optical signal has a power loss profile with less power variation over the optical transmission spectrum 24 than the optical signal. In an embodiment, the first portion of the optical signal is recombined with the second portion of the optical signal by the second optical coupler 22 of FIG. 1.

From the foregoing, those skilled in the art will appreciate that the optical filter 10 of FIG. 1 is able to output a spectrally modulated optical signal having a power loss profile with less power variation over the spectral power range than an optical signal received by the optical filter. Therefore, variable optical loss across the different channels is not made worse in later stages in the optical transmission process due to crosstalk in amplification stages or other power dependent effects.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

1. A tunable optical filter, comprising;
a first coupler configured to receive an optical signal and divide the optical signal into a first portion and a second portion;
a first waveguide operatively coupled to the first coupler, wherein the first waveguide is configured to receive the first portion of the optical signal;
a second waveguide operatively coupled to the first coupler, wherein the second waveguide is configured to receive the second portion of the optical signal;
an adjustable phase element operatively coupled to the first waveguide for adjusting an optical path length of the first waveguide;
a P-I-N junction operatively coupled to one of the first waveguide and the second waveguide for introducing a loss into one of the first portion of the optical signal and the second portion of the optical signal; and
a second coupler operatively coupled to the first waveguide and the second waveguide, wherein the second coupler is configured to recombine the first portion of the optical signal with the second portion of the optical signal to generate a spectrally modulated optical signal,
wherein the P-I-N junction is configured to introduce the loss by introducing free carriers into the one of the first waveguide and the second waveguide, and
wherein the loss is a function of waveguide cross-section and waveguide length.

2. The tunable optical filter of claim 1, wherein the adjustable phase element comprises a heater.

3. The tunable optical filter of claim 2, wherein the P-I-N junction is opera coupled to the first waveguide.

4. The tunable optical filter of claim 3, wherein the spectrally modulated optical signal has a flattened transmission power within the modulated optical transmission spectrum relative to a transmission power of the optical signal.

5. The tunable optical filter of claim 3, wherein the relative phase shift translates a transmission power profile laterally within the modulated optical transmission spectrum.

6. (canceled)

7. The tunable optical filter of claim 3, wherein the first portion of the optical signal comprises greater than fifty percent of a transmission power of the optical signal and the second portion of the optical signal comprises less than fifty percent of the transmission power of the optical signal.

8. The tunable optical filter of claim 3, wherein the first waveguide and the second waveguide each comprise silicon nanowire waveguides.

9. The tunable optical filter of claim 3, wherein a difference between a path length of the first waveguide and a path length of the second waveguide is such that a period of spectral modulation is between 40 nanometers (nm) and 80 nm at a reference wavelength of 1550 nm.

10. The tunable optical filter of claim 3, wherein a first path length of the first waveguide and a second path length of the second waveguide comprises a difference of 10 microns.

11. The tunable optical filter of claim 3, wherein the modulated optical transmission spectrum extends from a wavelength of 1530 nanometers (nm) to a wavelength of 1560 nm.

12. The tunable optical filter of claim 3, wherein the first coupler has a split ratio other than 50/50.

13. The tunable optical filter of claim 3, wherein the modulated optical transmission spectrum is based on a difference between a first waveguide path length and a second waveguide path length.

14. The tunable optical filter of claim 3, wherein the heater is configured to produce a transmission power profile of the optical signal within the modulated optical transmission spectrum, and wherein the transmission power profile within the modulated optical transmission spectrum is one of a bell shape and an inverted bell shape.

15. A method of tuning an optical signal, comprising:
routing a first portion of the optical signal to a first waveguide and a second portion of the optical signal to a second waveguide;
generating an adjustable phase shift in the first portion of the optical signal;
introducing an adjustable optical loss in one of the first portion of the optical signal and the second portion of the optical signal by introducing free carriers into one of the first waveguide and the second waveguide, respectively, wherein the adjustable optical loss is is a function of waveguide cross-section and waveguide length; and
recombining the first portion of the optical signal with the second portion of the optical signal to produce a spectrally modulated optical signal.

16. The method of claim 15, wherein the spectrally modulated optical signal has a power loss profile with less power variation over the modulated optical transmission spectrum than the optical signal.

17. The method of claim 15, further comprising providing the first waveguide and the second waveguide with different lengths to define the modulated optical transmission spectrum.

18. The method of claim 15, wherein the routing is performed by a first coupler, wherein the shifting is performed by a heater, wherein the introducing is performed by a P-I-N junction, and wherein the recombining is performed by a second coupler.

19. The method of claim 15, further comprising dividing the optical signal into the first portion and the second portion prior to the routing.
